(19) United States
(12) Patent Application Publication
(10) Pub. No.: US 2024/0423338 A1
(43) Pub. Date: Dec. 26, 2024

(54) TUBE HOLDER ACCESSORY FOR PORTABLE ELECTRONIC DEVICES

(71) Applicant: Case-Mate, Inc., Atlanta, GA (US)

(72) Inventors: Saumil Chetan MODY, Atlanta, GA (US); Jacob Andrew MCKENZIE, Smyrna, GA (US); Andrew HARPER, Lilburn, GA (US)

(73) Assignee: Case-Mate, Inc., Atlanta, GA (US)

(21) Appl. No.: 18/830,901

(22) Filed: Sep. 11, 2024

Related U.S. Application Data
(60) Provisional application No. 63/571,696, filed on Mar. 29, 2024.

(51) Int. Cl. A45C 11/00; A45C 13/10

(52) U.S. Cl. CPC A45C 11/00; A45C 13/1069; A45C 2011/007

(57) ABSTRACT

A tube-holding accessory for retaining a tube in connection with a mobile device. The accessory includes a magnetically or adhesively secured attachment portion for attaching the accessory to the mobile device and an engagement portion including a pair of resilient flanges for removably retaining a tube of lipstick or other tube-shaped personal item.

### CROSS-REFERENCE TO RELATED APPLICATIONS

This application claims priority to U.S. Provisional Patent Application Ser. No. 63/571,696 filed Mar. 29, 2024, which is incorporated herein by reference.

### TECHNICAL FIELD

The present invention relates generally to the field of accessories for mobile electronic devices, and more particularly to an accessory for attachment to a mobile phone or other portable electronic device to allow a user to secure tube-like articles to the mobile phone or other portable electronic device.

### BACKGROUND

It has been found that some users of mobile phones or other portable electronic devices may wish to secure other accessories or articles to their mobile electronic devices to reduce the number of loose articles to hold or carry on their persons. Accordingly, needs exist for improved accessories for mobile phones and other portable electronic devices to assist a user in securing items and reducing the number of loose articles to hold or carry on their person. It is to the provision of improved accessories for mobile phones and other portable electronic devices meeting these and other needs that the present invention is primarily directed.

### SUMMARY

In example embodiments, the present invention provides a magnetic, adhesive, or otherwise attached accessory apparatus for a mobile phone or other portable electronic device. The accessory apparatus can be attached to a phone or other mobile device, to a protective or decorative case containing the mobile device, integrally formed with a case for a mobile device, and/or configured for attachment or engagement with other accessories or components attached or engaged with the device.

In example embodiments, the accessory apparatus preferably includes an attachment portion comprising one or more permanent magnets, adhesive, engagement portions, or other attachment means providing strong and secure engagement with the phone or other electronic device, and an accessory adaptor portion for engaging other items or surfaces.

In further example embodiments of the present invention, the attachment portion optionally further comprises a front plate and an intermediate plate. The one or more permanent magnets are positioned, or otherwise provided, between the front and intermediate plates. The accessory adaptor portion comprises one or more features to engage the other items or surfaces.

In one aspect, the present invention relates to a tube-holder accessory for a mobile device, the tube-holder accessory including an attachment portion for attachment to the mobile device, and an engagement portion for releasably engaging a tube, the engagement portion including first and second flexible and resilient flanges defining a channel therebetween for releasably engaging the tube within the channel between the first and second flexible and resilient flanges.

In another aspect, the invention relates to a tube-holder accessory for a mobile device, the tube-holder accessory including an attachment portion comprising at least one magnetic element configured for engagement with a cooperative magnetic feature of the mobile device, and an engagement portion for releasably engaging a tube, the engagement portion including first and second flexible and resilient flanges defining a channel therebetween for releasably engaging the tube within the channel between the first and second flexible and resilient flanges.

In still another aspect, the invention relates to a tube-holder accessory for a mobile device, the tube-holder accessory including an attachment portion including an adhesive material configured for adhesion to the mobile device, and an engagement portion for releasably engaging a tube, the engagement portion including first and second flexible and resilient flanges defining a channel therebetween for releasably engaging the tube within the channel between the first and second flexible and resilient flanges

In another aspect, the present invention relates to a magnetic accessory apparatus for a mobile electronic device. The magnetic accessory apparatus preferably includes a magnetic attachment portion for attachment to the mobile electronic device and an adaptor portion for engaging other items or surfaces. Preferably, the magnetic attachment portion comprises a front plate, an intermediate plate, and one or more magnets embedded between the front and intermediate plates.

In another aspect, the adaptor portion comprises a plurality of resilient flanges defining one or more slots or grooves for receiving other loose articles such as for example small tubes and containers of personal care or medical products.

In another example embodiment, the present invention relates to a method of manufacturing a magnetic accessory for a mobile electronic device. The method comprises the steps of providing a first plate or panel having one or more grooves, embedding or placing one or more magnets in the one or more grooves, securing a second plate or panel to the first plate with the one or more magnets embedded between the first and second plates, securing the combined first and second plates to in a recessed area on the first side of a third plate, the third plate comprising an engaging element on its second side opposite its first side.

In yet another example embodiment, the present invention relates to a magnetic, adhesive or otherwise attached accessory for a mobile electronic device, and a method of use of such an accessory, for securing a tube or other container for holding personal care products to the mobile electronic device. The accessory comprises a magnetic, adhesive, or otherwise engageable attachment portion for attaching the accessory to the mobile electronic device. The attachment portion may comprise one or more permanent magnets, an adhesive material, or other engagement portions. The accessory further comprises an adaptor portion for receiving and retaining the personal care container, the adaptor portion comprising at least one slot defined by resilient flanges. The resilient flanges are configured to at least partially surround the container when the container is retained in the at least one slot.

These and other aspects, features and advantages of the invention will be understood with reference to the drawing figures and detailed description herein and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 shows an accessory apparatus for a mobile electronic device according to an example embodiment of the present invention with a portable container, such as for example a rigid tube for holding personal care products, releasably secured to the accessory apparatus.

FIG. 2 shows the accessory apparatus of FIG. 1 with another portable container, such as for example a squeezable tube for holding personal care products, releasably secured to the accessory apparatus.

FIG. 3A shows a front view of the accessory apparatus of FIG. 1.

FIG. 3B shows a back view of the accessory apparatus of FIG. 1.

FIG. 3C shows a side view of the accessory apparatus of FIG. 1.

FIG. 4A shows a first assembly view of a magnetically attachable accessory apparatus according to an example embodiment of the invention.

FIG. 4B shows a second assembly view of the magnetically attachable accessory apparatus.

FIGS. 5A and 5B (including Detail D) show sequential views of the method of attachment of the magnetic accessory apparatus to a portable electronic device.

FIGS. 6A and 6B show first and second assembly views of an adhesively attachable accessory apparatus according to an example embodiment of the invention.

FIGS. 7A, 7B and 7C (including Detail F) show sequential views of the method of attachment of the adhesive accessory apparatus to a portable electronic device.

FIGS. 8A and 8B show a sequence of operation of use of an accessory device with a portable electronic device, according to an example embodiment of the invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

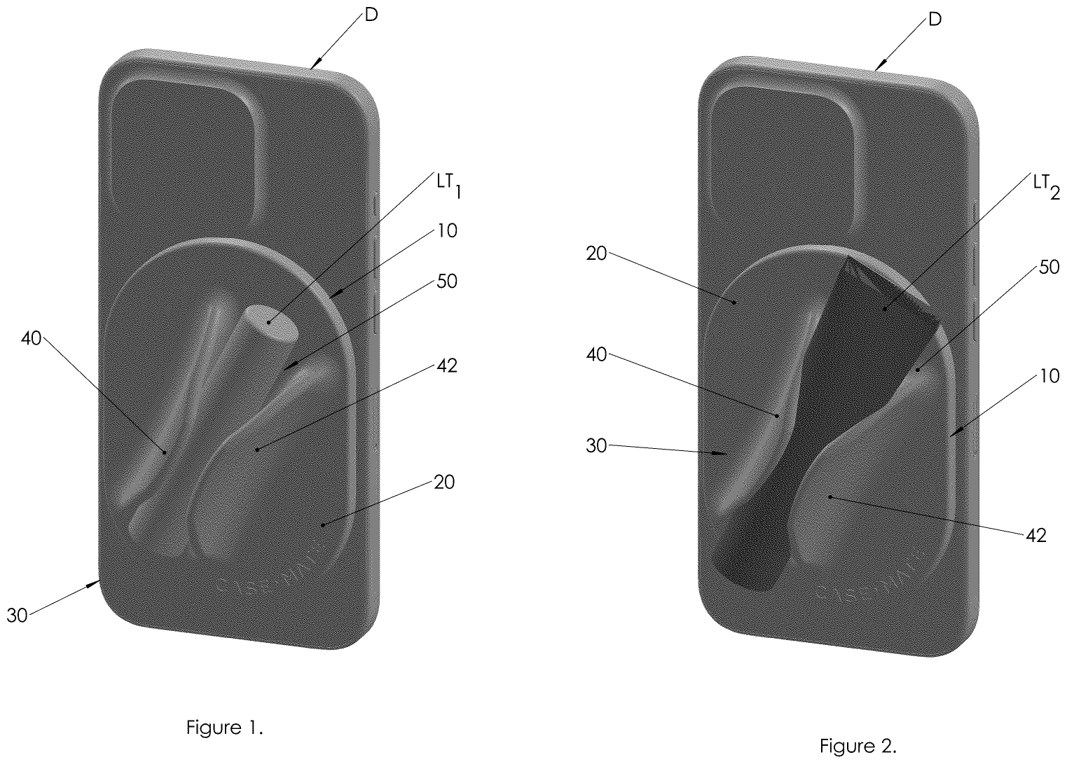

With reference now to the drawing figures, wherein like reference numbers represent corresponding parts throughout the several views, FIGS. 1, 2 and 3A, 3B and 3C show an example embodiment of an accessory apparatus 10 for attachment to or engagement with a mobile phone or other electronic device D. The accessory apparatus 10 generally comprises a magnetic, adhesive or otherwise engageable attachment portion 20 for securing the apparatus 10 to the mobile phone or other electronic device D (or to a case or other component(s) attached to the mobile phone or other electronic device). The accessory holder apparatus 10 further includes an engaging portion or element 30 for receiving and removably retaining other articles or items, such as for example personal care and lip treatment products such as lipsticks, lip-glosses, moisturizers, sunscreen, makeup, etc. In particular embodiments, the retained item may take the form or a rigid or squeezable tube. In example embodiments, the accessory holder 30 includes a pair of flanges or protrusions 40, 42 defining a slot or groove 50 for receiving and removably retaining a loose article or item therebetween. The slot 50 and flanges 40, 42 are generally configured to receive and retain items of various sizes and shapes. For example, FIG. 1 shows the accessory holder retaining a substantially rigid tube or cylindrical casing LT₁, such as a lipstick casing, having a first size and shape within the slot and flanges, and FIG. 2 shows the accessory holder retaining a squeezable tube LT₂, such as a tube of lip gloss or moisturizer, having generally a different size and shape from the cylindrical casing held within the same slot and flanges.

In example embodiments, inner surfaces of the of the flanges 40, 42 are arcuate, or at least partially arcuate, so as to define a generally cylindrical slot or groove 50 therebetween. In the depicted example embodiments, for example, the arcuate inner surfaces have radii of curvatures between about 16 mm and 25 mm to accommodate tubular articles having diameters between about 16 mm and 25 mm. The flanges 40, 42 are preferably at least partially flexible or resilient allowing them to be deformed or manipulated to accommodate articles of various sizes and shapes. Once an article is inserted in the slot between the flanges 40, 42, the flanges apply inward a degree of gripping force on the article to prevent it from becoming unintentionally dislodged, but to allow it to be intentionally removed with a moderate manual retraction force. In preferred example embodiments, the engagement portion 30 is made of, or at least partially comprises, silicone to provide a soft hand feel for the user and grip or friction to better hold articles between the flanges. In other example embodiments, the engagement portion 30 may comprise silicone in pre-determined areas about the engagement portion. For example, the engagement portion may comprise a polycarbonate (or other suitable rigid material) base panel with silicone flanges or engaging features secured to the polycarbonate base panel.

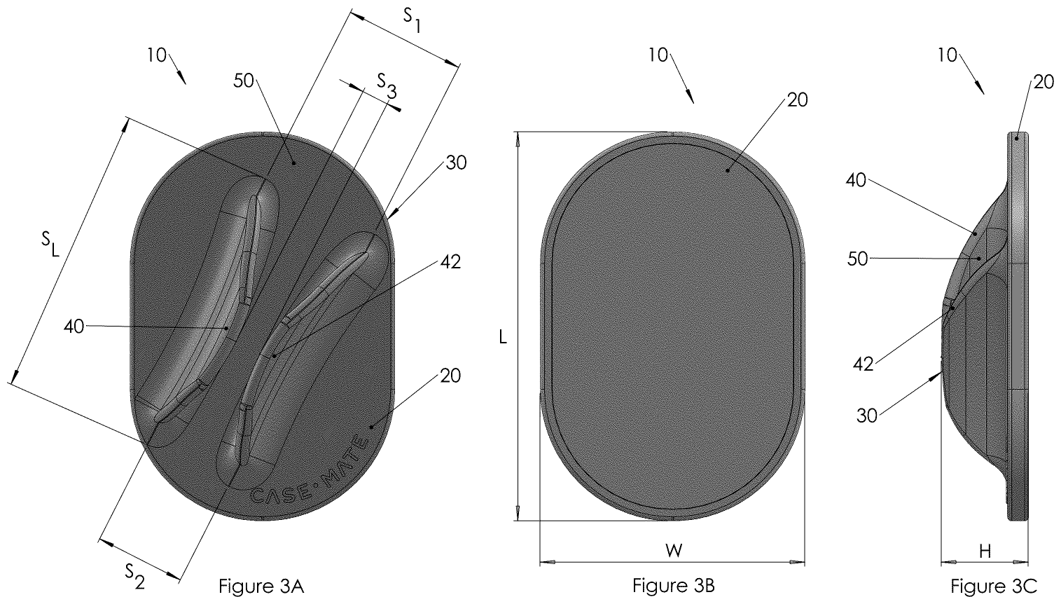

In example embodiments, and with reference to FIGS. 3A-3C, the slot 50 extends between a first opening or gap having a first gap or slot width S₁ at a first end of the slot and a second opening or gap having a second gap or slot width S₂ at a second end of the slot. The slot further comprises a third gap or slot width S₃ between the first and second ends, wherein the third gap or slot width is less than the first and second gap or slot widths. In example embodiments, the third gap width defines the minimum width or the narrowest gap along the slot. Optionally, the narrowest gap or slot width S₃ is not positioned exactly at the center of the elongate slot 50 but rather closer to either of the first or second ends of the slot so that the slot conforms more closely to the shape of common squeezable personal care and first-aid applicator tubes with a crimped closed end and a tubular open end. In the depicted example embodiment, for example, the narrowest gap along the slot S₃ is closer to the second opening S₂ than the first opening S₁. Preferably, the flanges are molded, or otherwise configured, to gradually flare out so that the slot gradually widens from the narrowest gap to each of the first and second openings. Optionally, the engagement portion 30 may further comprise a recessed or dimpled area between the flanges to better accommodate or seat the retained article or item within the slot, for example, an elongate and rounded recessed area or groove extending between the flanges The rounded recessed areas are configured to accommodate and properly seat the rounded exterior surfaces of the retained articles, such as lip stick cases, lip gloss tubes, etc.

According to example embodiments, the first and second slot widths S₁, S₂ are between about 10 mm and 30 mm, or more preferably between about 14 mm and 26 mm. In example embodiments, the third slot width S₃ is between about 5 mm and 20 mm, or more preferably between about 12 mm and 14 mm. Preferably, one of the first or second slot openings S₁, S₂ is wider than the other. In the depicted embodiment, for example, the first slot opening S₁ measures about 22.55 mm (i.e., the first width), the second slot opening S₂ measures about 14.25 mm (i.e., the second width), and the third slot width S₃ measures about 9 mm. In example embodiments, the length of the slot SL between the first and second opening S₁, S₂ is between about 50 mm and 60 mm, or more preferably about 59.55 mm, and the depth of the flanges 40, 42 from top of the flange to the bottom of the slot 50 is between about 15 mm and 20 mm, or more preferably about 17 mm.

As shown in FIGS. 3B and 3C, the accessory holder 10 comprises an overall width W, an overall length L, and an overall height H measured between the peak of the engagement element or flanges 40, 42 and the rear side or attachment surface of the attachment portion 20 of the accessory holder 10. In example embodiments, the accessory holder comprises an overall width W between about 70 mm and about 60 mm, an overall length L between about 90 mm and 100 mm, and an overall height H between about 15 mm and 25 mm. In the depicted embodiment, the accessory holder comprises an overall width W between about 70 mm and about 60 mm, an overall length L between about 90 mm and 100 mm, and an overall height H between about 15 mm and 25 mm. In further embodiments, the accessory holder comprises an overall width W of about 64 mm, an overall length L of about 94 mm, and an overall height H of about 22 mm.

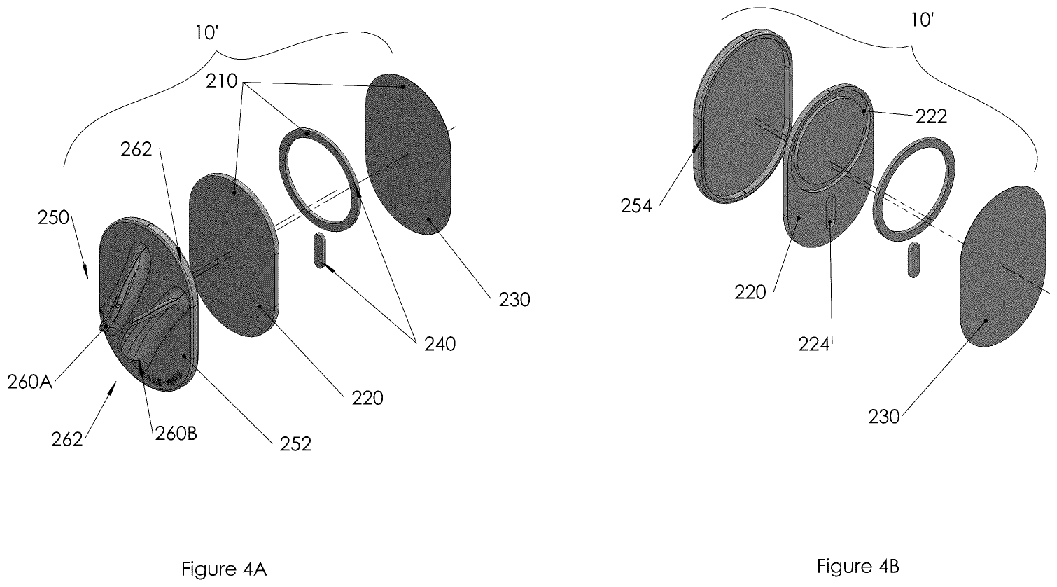

In some example embodiments of an accessory holder apparatus 10′, and with reference now to FIGS. 4A and 4B, the attachment portion or base 20 comprises at least one permanent magnet or magnetic element configured for magnetic attraction and attachment to one or more magnetic components within the phone or other mobile electronic device and/or to a case for the mobile device, such as for example the Apple MagSafe™ magnetic attachment system. In such embodiments, the magnetic attraction between the attachment base 20 and the mobile device D allows the accessory apparatus to be securely but removably affixed, and therefore removably attached, to the surface of the mobile device or a case or other components attached to the mobile device. In some embodiments, a case attached directly to the mobile device additionally or alternatively comprises one or more magnetic components that magnetically engage the holder apparatus. In example embodiments, the at least one magnet or magnetic element of the attachment base portion comprises a full or partial circular ring-shaped magnetic array of magnetic element(s) extending substantially continuously 360° around the generally annular body of the attachment base portion. In alternate embodiments, the accessory apparatus may be attached to a mobile device or case for a mobile device by other or additional attachment means such as hook-and-loop fasteners, releasable adhesive, detachable clips or other couplings, inter-engaging friction-fit elements, other magnetic arrangements, or the like. In some example embodiments, the accessory apparatus may further comprise an external magnet for attachment to a mobile phone or other electronic device not having magnets or otherwise not configured for magnetic attachment, in which case the external magnet preferably includes an adhesive or other attachment means for securing it to the mobile phone or other electronic device.

In the depicted embodiment of FIGS. 4A and 4B, the accessory apparatus or accessory holder 10′ generally includes a magnetic attachment portion 210 for securing the apparatus to the mobile phone or other electronic device (or to a case or other component(s) attached to the mobile phone or other electronic device). The magnetic attachment portion 210 generally includes a first plate or panel 220, a second plate or panel 230, and one or more magnets 240 embedded or otherwise provided between the first and second panels. In example embodiments, the first plate or panel 220 comprises one or more recesses or grooves 222, 224 for receiving the one or more magnets 240. The accessory holder 200 further includes an engagement or adaptor portion 250 for engaging other portable articles or items, such as for example portable containers for holding personal care and medical/first-aid products (see FIGS. 1 and 2), such as for example lip treatment products. The engagement portion 250 includes a third plate or panel 252 having a first side or surface and a second side or surface opposite the first side or surface. The engagement portion further includes engaging elements for holding and/or engaging other portable articles or items and/or support surfaces. In example embodiments, the engaging elements include a pair of flanges 260A, 260B extending generally transversely from the first side or surface of the third plate or panel 252 and defining a slot or groove 262 for receiving the loose portable articles or items. The engagement portion 250 further includes a raised edge or wall 254 extending transversely from the second side or surface of the third plate or panel 252 and around the perimeter thereof to define a recessed area or cavity for receiving the magnetic attachment portion 210.

In example embodiments, the first and/or second plates or panels of the magnetic attachment portion is/are made from substantially rigid materials while the engagement portion is made from a flexible and resilient material. In particular embodiments, for example, the first and second plates or panels are made from, or generally comprise, polycarbonate materials, whereas the engagement portion is made from, or generally at least partially comprises silicone, for example a 50A silicone.

Example methods of manufacture of an accessory apparatus according to the invention include the steps of providing a first plate having one or more grooves, embedding or placing one or more magnets in the one or more grooves, securing a second plate to the first plate with one or more magnets embedded between the first and second plates, securing the first and second plates to a recessed area along a first side of a third plate, wherein the third plate comprises an accessory engaging element on a second side opposite the first side.

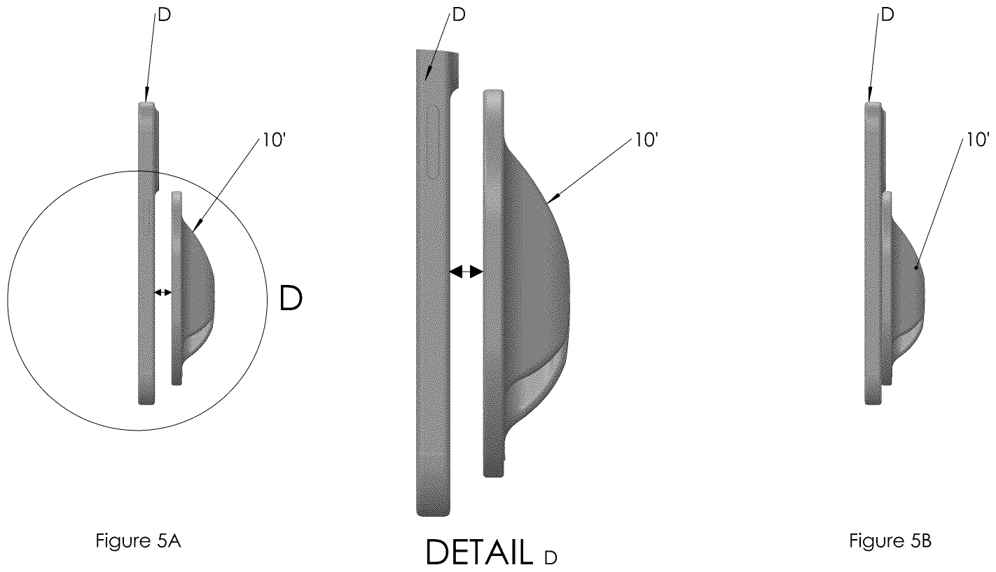

FIGS. 5A and 5B, including Detail D of FIG. 5A, show an example mode of use of the accessory holder 10′ in conjunction with a mobile device D (in the form of a mobile phone). The accessory holder 10′ is placed in proximity with the device D, for example along the back surface of the device opposite its display screen. The accessory holder 10′ is aligned with its magnetic features in cooperative magnetically-attracted position over or adjacent corresponding magnetic features of the device D, as shown in FIG. 5A. The accessory holder 10′ is then brought into contact with the device D, as shown in FIG. 5B, with their respective magnetic features engaged to retain the accessory holder in place on the device D.

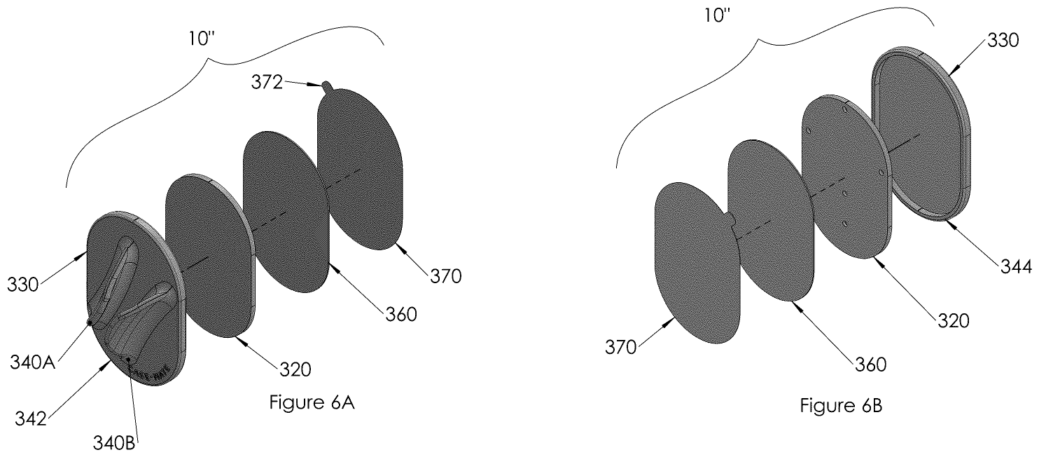

FIGS. 6A and 6B show another example embodiment of an accessory holder 10″ for use in connection with a portable electronic device D. In this embodiment, the accessory holder is adhesively attached to the device D, rather than by magnetic attachment. In the depicted example embodiment, the accessory holder 10″ includes an attachment plate or panel 320 having first and second faces. In example embodiments, the attachment plate or panel 320 comprises a substantially stiff or rigid material such as a polycarbonate or other polymeric material. The accessory holder 10″ includes an accessory retention or engagement portion 330, further including engaging elements for holding and/or engaging other portable articles or items and/or support surfaces. In example embodiments, the engaging elements include a pair of flexible and resilient flanges 340A, 340B extending generally transversely therefrom and defining a slot or groove 342 therebetween for receiving a loose portable article or item, such as for example, a tube of lip treatment product. The accessory engagement portion 330 optionally further includes a raised edge or wall 344 extending transversely from the opposite side or surface of and around the perimeter thereof to define a recessed area or cavity for receiving the attachment plate or panel 320. The accessory holder 10″ further includes an adhesive layer 360, such as for example a foam pressure-sensitive adhesive, for example, 3M™ VHB™ Specialty Tape 4930, or other permanent or repositionable adhesive capable of providing a high-strength and durable attachment of the accessory holder to the device D. A removable cover layer 370 is provided over the adhesive surface of the adhesive layer 360, optionally including a gripping tab 372, to enable a user to more easily grip and remove the cover layer to expose the adhesive for mounting the accessory holder 10″ to the device D.

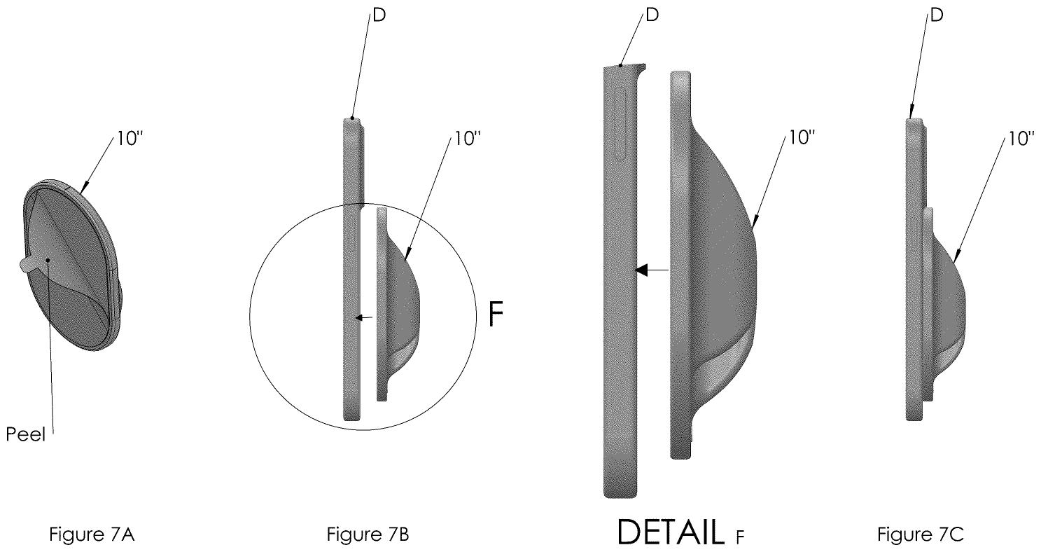

In an example mode or method of use, and with reference to FIGS. 7A, 7B and 7C, including Detail F of FIG. 7B, a user removes the cover layer 370 to expose the adhesive of the adhesive layer 360, places the accessory holder 10″ in a desired position with the adhesive layer adjacent the desired mounting position of the device D, and presses the accessory holder against the device to engage the adhesive and securely adhere the accessory holder to the device.

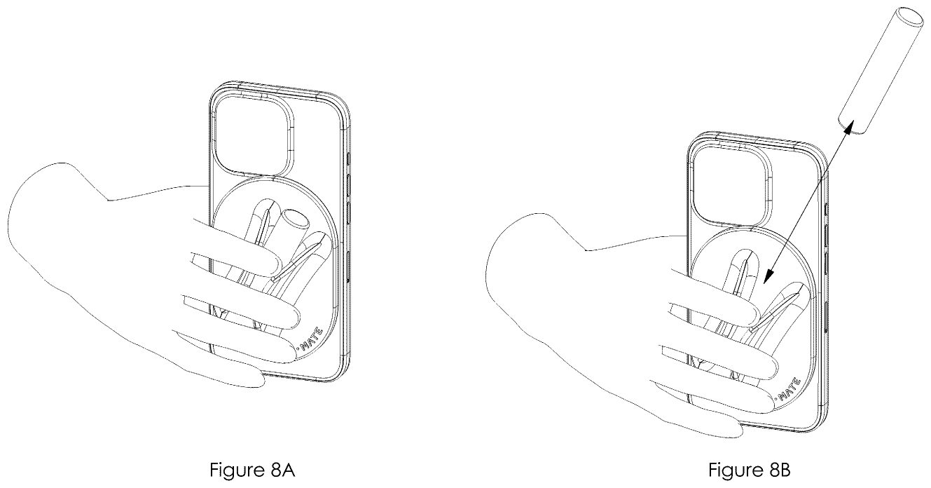

With reference to FIGS. 8A and 8B, example methods of use of an accessory apparatus 10, 10′, 10″ according to the invention further include the steps of providing an accessory apparatus as described herein; magnetically, adhesively, or otherwise attaching or otherwise engaging the accessory apparatus to a mobile device D such as a mobile phone or tablet computer, or to a case or other accessory engaged or engageable with a mobile device; operating the mobile device in standard fashion; and selectively engaging, removing and replacing an article or item with the accessory apparatus. For example, a user may selectively engage a personal care item (e.g., lipstick, lip-gloss, moisturizer, sunscreen, makeup, etc. in a rigid or squeezable tube) into the slot or groove between flexible flanges of the accessory apparatus as described herein, remove the item from the accessory apparatus for application and use, and replace the item into the accessory apparatus, as desired.

While the invention has been described with reference to example embodiments, it will be understood by those skilled in the art that a variety of modifications, additions and deletions are within the scope of the invention, as defined by the following claims.

What is claimed is:

1. A tube-holder accessory for a mobile device, the tube-holder accessory comprising:
an attachment portion for attachment to the mobile device; and
an engagement portion for releasably engaging a tube, the engagement portion comprising at least first and second flexible and resilient flange portions defining a channel therebetween for releasably engaging the tube within the channel between the first and second flexible and resilient flanges.

2. The tube-holder accessory of claim 1, wherein the attachment portion comprises at least one magnetic element, configured for engagement with a cooperative magnetic feature of the mobile device.

3. The tube-holder accessory of claim 2, wherein the at least one magnetic element comprises a ring-shaped element.

4. The tube-holder accessory of claim 2, wherein attachment portion comprises a first plate and a second plate and wherein the at least one magnetic element is embedded between the first and second plate.

5. The tube-holder accessory of claim 1, wherein the attachment portion comprises an adhesive.

6. The tube-holder accessory of claim 5, wherein the adhesive comprises a foam pressure-sensitive adhesive.

7. The tube-holder accessory of claim 5, wherein the adhesive comprises a permanent adhesive.

8. The tube-holder accessory of claim 1, wherein the channel between the first and second flanges comprises a first width at a first end of the channel, a second width at an opposite second end of the channel, and a third width between the first and second ends of the channel, the third width being less than the first and second widths.

9. The tube-holder accessory of claim 8, wherein the first and second widths are different.

10. The tube-holder accessory of claim 8, wherein the first and second widths are between about 17.5 mm and 24 mm.

11. The tube-holder accessory of claim 8, wherein the third width is about 13 mm.

12. The tube-holder accessory of claim 1, wherein the channel between the first and second flexible and resilient flanges has a length of at least 50 mm.

13. The tube-holder accessory of claim 1, wherein at least one of the first and second flanges comprise an arcuate inner surface.

14. The tube-holder accessory of claim 13, wherein the arcuate inner surface defines a radius of curvature between about 16 mm and 25 mm.

15. The tube-holder accessory of claim 1, wherein the first and second flanges at least partially comprise silicone.

16. The tube-holder accessory of claim 1, wherein the engagement portion is configured for releasably engaging a tube of a personal care material selected from a tube of lipstick, a tube of lip gloss, a tube of moisturizer, a tube of sunscreen, and a tube of makeup.

17. A tube-holder accessory for a mobile device, the tube-holder accessory comprising:
an attachment portion comprising at least one magnetic element, configured for engagement with a cooperative magnetic feature of the mobile device; and
an engagement portion for releasably engaging a tube, the engagement portion comprising first and second flexible and resilient flanges defining a channel therebetween for releasably engaging the tube within the channel between the first and second flexible and resilient flanges.

18. The tube-holder accessory of claim 17, wherein the at least one magnetic element comprises a ring-shaped element.

19. The tube-holder accessory of claim 18, wherein attachment portion comprises a first plate and a second plate, and wherein the at least one magnetic element is embedded between the first and second plate.

20. The tube-holder accessory of claim 17, wherein the engagement portion is configured for releasably engaging a tube of a personal care material selected from a tube of lipstick, a tube of lip gloss, a tube of moisturizer, a tube of sunscreen, and a tube of makeup.

21. A tube-holder accessory for a mobile device, the tube-holder accessory comprising:
an attachment portion comprising an adhesive material configured for adhesion to the mobile device; and
an engagement portion for releasably engaging a tube, the engagement portion comprising first and second flexible and resilient flanges defining a channel therebetween for releasably engaging the tube within the channel between the first and second flexible and resilient flanges.

22. The tube-holder accessory of claim 21, wherein the adhesive material comprises a foam pressure-sensitive adhesive.

23. The tube-holder accessory of claim 21, wherein the adhesive material comprises a permanent adhesive.

24. The tube-holder accessory of claim 21, wherein the engagement portion is configured for releasably engaging a tube of a personal care material selected from a tube of lipstick, a tube of lip gloss, a tube of moisturizer, a tube of sunscreen, and a tube of makeup.
